(19) United States
(12) Patent Application Publication
(10) Pub. No.: US 2026/0328374 A1
(43) Pub. Date: Oct. 22, 2026

(54) STAND LIGHT

(71) Applicant: Nanjing Chervon Industry Co., Ltd., Nanjing (CN)

(72) Inventors: Changwei ZUO, Nanjing (CN); Minggui XIAO, Nanjing (CN); Zhenxing TAI, Nanjing (CN); Lai LIU, Nanjing (CN)

(73) Assignee: Nanjing Chervon Industry Co., Ltd., Nanjing (CN)

(21) Appl. No.: 19/454,464

(22) Filed: Jan. 21, 2026

(30) Foreign Application Priority Data
Apr. 16, 2025 (CN) 202510474790.5
Apr. 16, 2025 (CN) 202520715795.8

(51) Int. Cl. F21V 21/28; F21S 9/02; F21V 14/02; F21V 21/06; F21V 21/22; F21V 23/02; F21W 131/10

(52) U.S. Cl. CPC F21V 21/28; F21S 9/02; F21V 14/02; F21V 21/06; F21V 21/22; F21V 23/02; F21W 2131/1005

(57) ABSTRACT

A stand light includes an elongate body defining a vertical axis of the stand light; a plurality of support legs pivotally connected to the elongate body for supporting the elongate body to stand upright; a light-emitting assembly mounted above the elongate body, where the light-emitting assembly includes a base and a plurality of lamp heads; and a battery pack mounted to the elongate body for supplying power to the light-emitting assembly. Each of the lamp heads is independently arranged to rotate about a first axis and a second axis perpendicular to the first axis, where the first axis is a radial direction of the elongate body.

### CROSS REFERENCE TO THE RELATED APPLICATIONS

This application is based upon and claims priority to Chinese Patent Application No. 202510474790.5, filed on Apr. 16, 2025, and Chinese Patent Application No. 202520715795.8, filed on Apr. 16, 2025, the entire contents of which are incorporated herein by reference.

### TECHNICAL FIELD

The present application relates to a lighting fixture, particularly to a stand light.

### BACKGROUND

Lighting fixtures are needed to illuminate the environment at night or in dim light to facilitate people's production and daily life. Lighting fixtures include fixed lamps and movable stand lights. Specifically, the stand lights have unique practical advantages in construction site environments, especially in terms of temporary lighting, flexibility, and safety. The stand lights do not require wiring or damage to the building structure and can be repositioned according to the construction progress (e.g., moved from a foundation pit to a high floor). They are also suitable for temporary lighting needs such as nighttime overtime work, narrow corners and material storage areas, and can provide directional illumination. However, in the prior art, the illumination direction of the lamp head of the stand light is not easily adjustable, making it difficult to quickly and flexibly adjust different illumination angles when used on the construction sites. Furthermore, the stand light occupies a large amount of space and is inconvenient to store.

This section provides background information related to the present application, and this background information is not necessarily prior art.

### SUMMARY

An objective of the present application is to solve or at least mitigate some or all of the above-mentioned problems.

A stand light includes: an elongate body defining a vertical axis of the stand light; a plurality of support legs pivotally connected to the elongate body for supporting the elongate body to stand upright; a light-emitting assembly mounted above the elongate body, where the light-emitting assembly includes a base and a plurality of lamp heads; and a battery pack mounted to the elongate body for supplying power to the light-emitting assembly. Each of the lamp heads is independently arranged to rotate about a first axis and a second axis perpendicular to the first axis, where the first axis is a radial direction of the elongate body.

In some embodiments, a position of the first axis is fixed relative to the base, and a position of the second axis changes as the lamp head rotates along the first axis.

In some embodiments, the lamp head includes a pivot knuckle, a pivot bracket and a light-emitting panel, where the pivot knuckle allows the pivot bracket and the light-emitting panel to rotate relative to the base about the first axis, and the pivot bracket allows the light-emitting panel to rotate relative to the pivot knuckle about the second axis.

In some embodiments, first axes of the plurality of lamp heads are coplanar with the vertical axis, respectively.

In some embodiments, a maximum rotation angle of the lamp head about the first axis is 165°, and a maximum rotation angle of the lamp head about the second axis is 310°.

In some embodiments, the base is allowed to rotate relative to the elongate body about the vertical axis.

In some embodiments, a shelf is mounted on the elongate body, the shelf is provided below the light-emitting assembly, the elongate body includes a telescopic tube assembly, and a height difference between the shelf and the light-emitting assembly is adjusted by the telescopic tube assembly.

In some embodiments, the stand light further includes a cover plate provided on a top of the telescopic tube assembly and a support plate provided below the cover plate, where the cover plate and the support plate form a circumferential groove, at least a part of the base is clamped in the circumferential groove, and the base is arranged to rotate about the circumferential groove.

In some embodiments, an elastic element is provided between the base and the support plate or the cover plate.

In some embodiments, a matching stop rib is provided between the base and the cover plate or the support plate, where the stop rib restricts a rotation angle of the base.

In some embodiments, when the light-emitting assembly includes three or fewer lamp heads, a plurality of light-emitting panels are allowed to rotate to have an approximately identical orientation.

A stand light includes: an elongate body defining a vertical axis of the stand light; a plurality of support legs pivotally connected to the elongate body for supporting the elongate body to stand upright; a light-emitting assembly mounted above the elongate body, where the light-emitting assembly includes a base and a plurality of lamp heads, and each of the lamp heads includes a pivoting assembly and a light-emitting panel; a battery pack mounted to the elongate body for supplying power to the light-emitting assembly; and a shelf mounted on the elongate body and provided below the light-emitting assembly. The plurality of lamp heads are arranged to rotate until the light-emitting panels face the shelf, and when the plurality of light-emitting panels face the shelf, the shelf protrudes beyond the lamp heads in a radial direction of the elongate body.

In some embodiments, taking the elongate body as a center, a radius of the shelf is greater than or equal to 150 mm and less than or equal to 300 mm.

In some embodiments, the shelf is in a form of a tray or a loop.

In some embodiments, a height of the stand light in a storage state is less than or equal to 1000 mm.

In the stand light provided by the present application, support legs are provided on the elongate body for supporting. The light-emitting assembly is mounted above the elongate body, and the lamp head of the light-emitting assembly has two degrees of rotational freedom and can rotate along the first axis and the second axis. Through the above-mentioned arrangement, the illumination angle of the lamp head can be quickly and flexibly adjusted according to the on-site need, thereby effectively meeting actual lighting needs. Furthermore, when the stand light is stored, the lamp heads are repositioned and rotated until the light-emitting panels face the shelf, so that the shelf protrudes beyond the lamp heads, thus reducing the space occupied by the lamp heads.

A lamp includes: a body; a light-emitting assembly mounted to the body, where the light-emitting assembly includes at least one lamp head and a pivoting assembly; and a power source provided in the body for supplying power to the light-emitting assembly. The pivoting assembly includes a damping assembly, and the damping assembly includes a first deformation element surrounding a pivoting shaft of the pivoting assembly and a second deformation element sleeved outside the first deformation element. The second deformation element deforms under a radially inward pressure and compresses the first deformation element, and the first deformation element deforms under compression of the second deformation element and generates a radially outward counterforce.

In some embodiments, the second deformation element and the first deformation element shrink in diameter under the pressure.

In some embodiments, the first deformation element is a C-ring, and the second deformation element is a circumferential fin.

In some embodiments, the pivoting assembly includes a first component and a second component that rotate relative to each other, where the damping assembly is provided on the first component, and the second component applies the pressure to the second deformation element.

In some embodiments, the lamp is a stand light, the body includes a telescopic tube assembly, the telescopic tube assembly includes at least an inner tube and an outer tube, and clamps are respectively fastened to the inner tube and the outer tube to secure a relative position of the inner tube and the outer tube.

In some embodiments, the telescopic tube assembly further includes an elastic part, and the elastic part is provided between the clamp and the inner tube.

In some embodiments, the elastic part is a rubber ring, and is fastened to the outside of the inner tube by a plastic retaining ring.

In some embodiments, the power source is an alternating current (AC) power source.

In some embodiments, the power source is a battery pack.

In some embodiments, the battery pack is detachable for powering a power tool.

In the lamp provided in the present application, a light-emitting assembly is provided on the body. The light-emitting assembly includes at least one lamp head and a pivoting assembly. The pivoting assembly includes a damping assembly, and the damping assembly includes a first deformation element surrounding a pivoting shaft and a second deformation element sleeved outside the first deformation element. When the illumination angle of the lamp head is adjusted by rotation, the damping force is generated at the pivoting shaft due to the interaction of forces between the first deformation element and the second deformation element, thereby allowing for quick adjustment of the illumination angle of the lamp head as needed, and being easy to operate.

### BRIEF DESCRIPTION OF THE DRAWINGS

FIG. 1 is a schematic diagram from one perspective of an embodiment of the present application;

FIG. 2 is a schematic diagram from another perspective of an embodiment of the present application;

FIG. 3 is a schematic diagram showing the lamp heads in a storage state in an embodiment of the present application;

FIG. 4 is a schematic diagram showing the lamp heads in a movable sleeve in an embodiment of the present application;

FIG. 5 is a schematic diagram showing one lamp head in an unfolded state in an embodiment of the present application;

FIG. 6 is a schematic diagram showing all lamp heads in an unfolded state in an embodiment of the present application;

FIG. 7 is a schematic diagram showing all lamp heads substantially on the identical side in an embodiment of the present application;

FIG. 8 is a schematic diagram showing all lamp heads in a storage state in an embodiment of the present application;

FIG. 9 is a schematic diagram showing the installation of a base in an embodiment of the present application;

FIG. 10 is a schematic diagram showing a damping assembly in an embodiment of the present application;

FIG. 11 is an exploded view of FIG. 10;

FIG. 12 is a cross-sectional view of a telescopic tube assembly in an embodiment of the present application;

FIG. 13 is an exploded view of one type of telescopic tube assembly in an embodiment of the present application; and

FIG. 14 is an exploded view of another type of telescopic tube assembly in an embodiment of the present application.

In the figures:
100. stand light; 1. elongate body; 11. vertical axis; 12. handle; 121. bracket locking switch; 13. telescopic tube assembly; 131. inner tube; 132. outer tube; 133. elastic part; 134. plastic retaining ring; 135. first circumferential fin; 136. C-shaped steel wire retaining ring; 14. clamp; 2. support leg; 3. light-emitting assembly; 31. lamp head; 311. pivoting assembly; 3111. pivot knuckle; 3112. pivot bracket; 3113. second component; 3114. damping assembly; 31141. first deformation element; 31142. second deformation element; 3115. pivoting shaft; 3116. first component; 312. light-emitting panel; 32. base; 321. elastic element; 33. first axis; 34. second axis; 4. battery pack; 5. shelf; 6. cover plate; 7. support plate; and 8. movable sleeve.

### DETAILED DESCRIPTION OF THE EMBODIMENTS

Before any examples of the present application are explained in detail, it is to be understood that the present application is not limited to its application to the structural details and the arrangement of components set forth in the following description or illustrated in the above drawings.

In the present application, the terms “comprising”, “including”, “having” or any other variation thereof are intended to cover an inclusive inclusion such that a process, method, article or device including a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device including that element.

In the present application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in the present application generally indicates that the contextual associated objects belong to an “and/or” relationship.

In the present application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate member and the two members or assemblies are connected by the at least one intermediate member. In addition, “connection” and “coupling” are not limited to physical or mechanical connections or couplings, and may include electrical connections or couplings.

In the present application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In the present application, those skilled in the art will understand that a function performed by an assembly may be performed by one assembly, multiple assemblies, one member, or multiple members. Likewise, a function performed by a member may be performed by one member, an assembly, or a combination of members.

In the present application, the terms “up”, “down”, “left”, “right”, “front”, and “rear” and other directional words are described based on the orientation or positional relationship shown in the drawings, and should not be understood as limitations to the examples of the present application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Stand lights have unique practical advantages in construction site environments, especially in terms of temporary lighting, flexibility, and safety. The stand lights do not require wiring or damage to the building structure and can be repositioned according to the construction progress (e.g., moved from a foundation pit to a high floor). They are also suitable for temporary lighting needs such as nighttime overtime work, narrow corners and material storage areas, and can provide directional illumination.

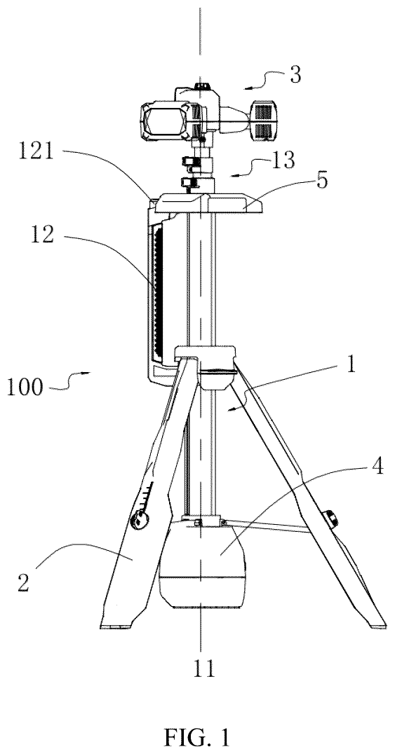

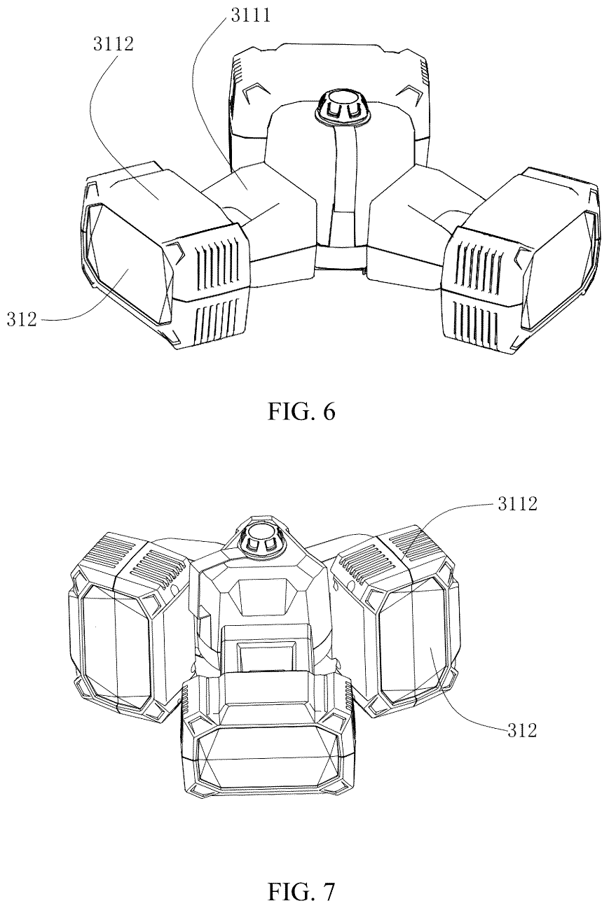

To enable quick adjustment of the illumination angle during use of the stand light, thereby flexibly meeting the needs on different illumination angles, and to reduce the occupied space during storage, as shown in FIGS. 1-14, the present application provides the stand light 100. The stand light 100 includes the elongate body 1, a plurality of support legs 2, the light-emitting assembly 3, and the battery pack 4.

Specifically, the elongate body 1 defines the vertical axis 11 of the stand light 100. The plurality of support legs 2 are pivotally connected to the elongate body 1, and the plurality of support legs 2 support the elongate body 1 to stand upright. The light-emitting assembly 3 is mounted above the elongate body 1, and the light-emitting assembly 3 includes the base 32 and a plurality of lamp heads 31. The battery pack 4 is mounted to the elongate body 1, and the battery pack 4 supplies power to the light-emitting assembly 3. Each of the lamp heads 31 is independently arranged to rotate about the first axis 33 and the second axis 34 perpendicular to the first axis 33, where the first axis 33 is the radial direction of the elongate body 1.

Through the above-mentioned arrangement, the illumination angle of the lamp head 31 can be quickly and flexibly adjusted according to the on-site need, thereby effectively meeting actual lighting needs. Furthermore, when the stand light 100 is stored, the lamp heads 31 are repositioned and rotated until the light-emitting panels 312 face the shelf 5, so that the shelf 5 protrudes beyond the lamp heads 31, thus reducing the space occupied by the lamp heads 31.

In some embodiments, the stand light 100 takes the rechargeable battery set as a power source. In this embodiment, the battery set is the battery pack 4, and the battery pack 4 cooperates with the corresponding power circuit to supply power to the stand light 100. Those skilled in the art should understand that in other embodiments, the stand light 100 can also be powered by other power source devices; for example, the power source can be the AC wire connected to the mains supply, or it can be other connecting cables that can be connected to the power source device. Mains supply or other power source device cooperates with the corresponding rectification, filtering, and voltage regulation circuits to provide power to the stand light 100. The battery pack 4 will be used in place of the power source below, but this should not be construed as the limitation to the scope of the present application.

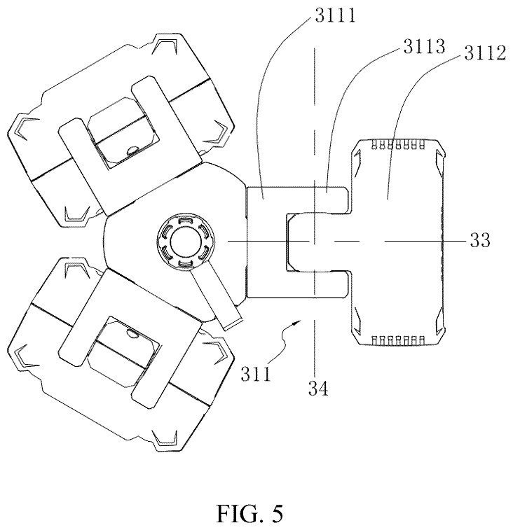

As shown in FIG. 5, in some embodiments, the position of the first axis 33 is fixed relative to the base 32, and the position of the second axis 34 changes as the lamp head 31 rotates along the first axis 33. By rotating the lamp head 31 about the first axis 33 and the second axis 34, the illumination angle of the lamp head 31 can be flexibly adjusted to meet the lighting needs in a plurality of directions.

As shown in FIGS. 5-8, in some embodiments, the lamp head 31 includes the pivoting assembly 311 and the light-emitting panel 312. The pivoting assembly 311 includes the pivot knuckle 3111 and the pivot bracket 3112. The pivot knuckle 3111 allows the pivot bracket 3112 and the light-emitting panel 312 to rotate relative to the base 32 about the first axis 33, and the pivot bracket 3112 allows the light-emitting panel 312 to rotate relative to the pivot knuckle 3111 about the second axis 34. The light-emitting panel 312 is mounted on the pivot bracket 3112. By rotating the pivot knuckle 3111, the pivot bracket 3112 and the light-emitting panel 312 can be driven to rotate about the first axis 33, thereby adjusting the illumination range of the light-emitting panel 312. By rotating the pivot bracket 3112, the light-emitting panel 312 can be driven to rotate, thereby adjusting the illumination angle of the light-emitting panel 312. By controlling the rotation of the lamp head 31 about the first axis 33 and/or the second axis 34, the illumination angle and range of the light-emitting panel 312 can be flexibly adjusted to achieve directional illumination.

In some embodiments, the first axes 33 of the plurality of lamp heads 31 are coplanar with the vertical axis 11, respectively. By arranging the plurality of lamp heads 31 on the base 32, 360° illumination without blind spots can be achieved. Furthermore, since the first axes 33 of the plurality of lamp heads 31 are coplanar with the vertical axis 11, respectively, it is convenient to arrange the plurality of lamp heads 31 on the base 32, thereby maximizing the illumination coverage area with the minimum number of lamp heads 31.

In some embodiments, the maximum rotation angle of the lamp head 31 about the first axis 33 is 165°, and the maximum rotation angle of the lamp head 31 about the second axis 34 is 310°. During the rotation of the lamp head 31 about the first axis 33 and the second axis 34, the wire electrically connected to the lamp head 31 will be pulled. Therefore, by limiting the maximum rotation angle of the lamp head 31 about the first axis 33 and the maximum rotation angle of the lamp head 31 about the second axis 34, the flexible adjustment of the illumination angle and range can be ensured while avoiding pulling-induced damage to the wire.

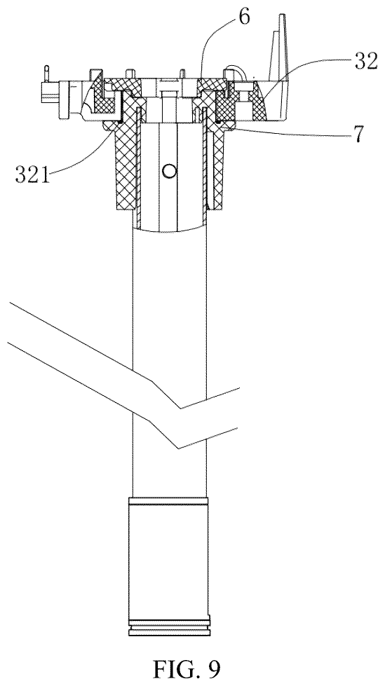

As shown in FIG. 1 and FIG. 9, in some embodiments, the base 32 can rotate relative to the elongate body 1 about the vertical axis 11. Since the base 32 can rotate about the vertical axis 11, all the lamp heads 31 are simultaneously driven to rotate during the rotation of the base 32, thereby allowing for more flexible adjustment of the illumination angle and illumination range of the lamp heads 31. Furthermore, when one or more lamp heads 31 malfunction, by rotating the base 32, the lamp heads 31 working normally can be used to illuminate critical areas or areas requiring urgent lighting, thus better meeting the on-site use.

As shown in FIG. 1, in some embodiments, the shelf 5 is mounted on the elongate body 1, and the shelf 5 is provided below the light-emitting assembly 3. The elongate body 1 includes the telescopic tube assembly 13, and the height difference between the shelf 5 and the light-emitting assembly 3 is adjusted by the telescopic tube assembly 13. The shelf 5 facilitates the placement of items. The telescopic tube assembly 13 allows for adjustment of the height difference between the shelf 5 and the light-emitting assembly 3 according to actual needs, thereby adjusting the height of the light-emitting assembly 3. At the construction site, targeting at the illumination at different positions, adjusting the height of the light-emitting assembly 3 can further ensure the lighting effect. After use, the height of the elongate body 1 can be adjusted by the telescopic tube assembly 13 to minimize the height of the elongate body 1, thus reducing the occupied space and facilitating organization during storage.

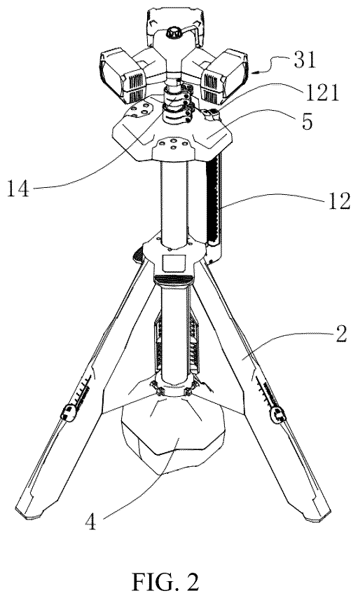

As shown in FIG. 2, in some embodiments, the shelf 5 is in the form of the tray or the loop. At the construction site, items such as screws, bolts, nuts, nails and wrenches are used. When placed haphazardly, these items are inconvenient to use due to the cluttered on-site environment and may even cause injury to construction workers. When the shelf 5 is the tray, items such as screws, bolts, nuts, nails and wrenches can be placed on the shelf 5 for easy access by the construction workers, preventing injury to construction workers. In another embodiment, the shelf 5 is the loop for hanging tool bags, clothing of the construction workers, etc., which are not further limited herein.

In some embodiments, the stand light 100 further includes the cover plate 6 provided on the top of the telescopic tube assembly 13 and the support plate 7 provided below the cover plate 6. The cover plate 6 and the support plate 7 form a circumferential groove, at least a part of the base 32 is clamped in the circumferential groove, and the base 32 is arranged to rotate about the circumferential groove. Through the above-mentioned arrangement, the cover plate 6 and the support plate 7 limit the base 32 along the vertical axis 11, thereby ensuring that the position of the base 32 relative to the cover plate 6 and the support plate 7 remains unchanged along the vertical axis 11. The above-mentioned structure is adopted to facilitate the installation of the base 32. Furthermore, since the base 32 can rotate about the circumferential groove, the degree of freedom of rotation of the base 32 is ensured.

As shown in FIG. 9, in some embodiments, the elastic element 321 is provided between the base 32 and the support plate 7 or the cover plate 6. By providing the elastic element 321, when the base 32 is mounted in the circumferential groove, the elastic element 321 undergoes elastic deformation under the compression of the base 32. Under the action of the own elastic restoring force of the elastic element 321, the elastic element 321 abuts against the base 32. During the rotation of the base 32 about the circumferential groove, sliding friction occurs between the elastic element 321 and the base 32, thereby playing the damping role and providing the damping sensation when the base 32 is rotated. Simultaneously, by providing the elastic element 321, the base 32 can be prevented from rotating freely. In an embodiment, the elastic element 321 is a rubber ring. The rubber ring is used as the elastic element 321 to provide a certain degree of rebound after compression, thereby effectively providing a friction during the rotation of the base 32.

In some embodiments, the matching stop rib is provided between the base 32 and the cover plate 6 or the support plate 7, and the stop rib restricts the rotation angle of the base 32. There are two stop ribs, where one stop rib is fixedly provided on the cover plate 6 or the support plate 7, and the other stop rib is fixedly provided on the base 32. During the rotation of the base 32 about the circumferential groove, the stop rib rotates with the base 32. When the two stop ribs abut, the rotation of the base 32 is restricted. The above-mentioned arrangement effectively limits the rotation angle of the base 32.

As shown in FIG. 7, in some embodiments, when the light-emitting assembly 3 includes three or fewer lamp heads 31, the plurality of light-emitting panels 312 can rotate to have an approximately identical orientation. Through the above-mentioned arrangement, when the range of directional illumination and the illumination intensity need to be ensured, all the lamp heads 31 are rotated to have an identical orientation, so that the position required for illumination can be sufficiently illuminated.

As shown in FIGS. 1-14, the present application also provides the stand light 100, and the stand light 100 includes the elongate body 1, the plurality of support legs 2, the light-emitting assembly 3, the battery pack 4, and the shelf 5.

Specifically, the elongate body 1 defines the vertical axis 11 of the stand light 100. The plurality of support legs 2 are pivotally connected to the elongate body 1, and the plurality of support legs 2 support the elongate body 1 to stand upright. The light-emitting assembly 3 is mounted above the elongate body 1, and the light-emitting assembly 3 includes the base 32 and the plurality of lamp heads 31. Each of the lamp heads 31 including the pivoting assembly 311 and the light-emitting panel 312. The battery pack 4 is mounted to the elongate body 1 for supplying power to the light-emitting assembly 3. The shelf 5 is mounted to the elongate body 1, and the shelf 5 is provided below the light-emitting assembly 3. The plurality of lamp heads 31 are arranged to rotate until the light-emitting panels 312 face the shelf 5, and when the plurality of light-emitting panels 312 face the shelf 5, the shelf 5 protrudes beyond the lamp heads 31 in the radial direction of the elongate body 1.

Through the above-mentioned arrangement, during the use of the stand light 100, the lamp heads 31 can be rotated according to actual needs, thereby adjusting the illumination direction and angle of the lamp heads 31, well meeting the on-site use. The shelf 5 facilitates the placement of items such as screws, bolts, nuts, nails and wrenches, thus facilitating subsequent use. After the use of the stand light 100 is completed, the lamp heads 31 can be rotated to face the shelf 5, which reduces the space occupied by the stand light 100 and facilitates the storage. In addition, since the shelf 5 protrudes relative to the lamp heads 31, when objects or pedestrians outside come into contact with the stand light 100, they will first come into contact with the shelf 5, thus providing a certain degree of protection for the lamp heads 31.

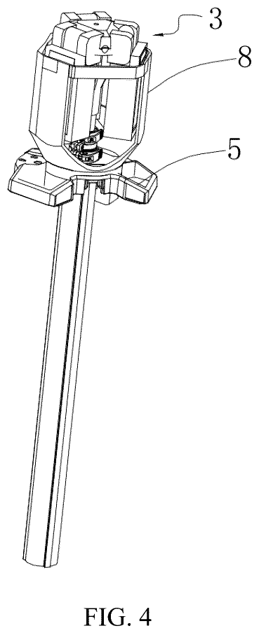

As shown in FIG. 4, in some embodiments, to prevent the light-emitting panels 312 of the lamp heads 31 in a storage state from being damaged by accidental impact, the movable sleeve 8 can be sleeved onto the light-emitting panels 312 of the lamp heads 31. The movable sleeve 8 adopts the hollow design, reducing the weight of the movable sleeve 8 while facilitating operation by the user to the movable sleeve 8. During the use of the stand light 100, the user removes the movable sleeve 8 from the light-emitting panels 312 to ensure that the light-emitting panels 312 can provide normal and effective illumination. After use and storage of the stand light 100, the movable sleeve 8 is sleeved on the light-emitting panels 312 to protect the light-emitting panels 312. In some embodiments, the movable sleeve 8 can also be integrated on the shelf 5. When the stand light 100 is in the storage state, the lamp heads 31 are directly inserted into the movable sleeve 8.

In some embodiments, three lamp heads 31 are mounted on the base 32, and each of the lamp heads 31 has two degrees of rotational freedom. The lamp heads 31 are independently arranged to rotate about the first axis 33 and the second axis 34 perpendicular to the first axis 33, where the first axis 33 is the radial direction of the elongate body 1. When the lamp heads 31 are stored, the lamp heads 31 are located below the base 32, and the light-emitting panels 312 face away from the direction of the elongate body 1. Even with the light-emitting panels 312 facing downwards, the working range will not be lower than the base 32, and the extreme position of the lamp head 31 is achieved when the lamp head 31 is horizontal. The shelf 5 is designed as the cylindrical structure, and when the lamp heads 31 are stored, the light-emitting panels 312 of the lamp heads 31 face the annular wall surface of the shelf 5.

In some embodiments, when the second axis 34 is parallel to the plane where the shelf 5 is located, the lamp heads 31 can be rotated until the light-emitting panels 312 face the shelf 5. Through the above-mentioned arrangement, the lamp heads 31 can only be stored into place when the lamp heads 31 are adjusted such that the second axis 34 is parallel to the plane where the shelf 5 is located.

In some embodiments, taking the elongate body 1 as the center, the radius of the shelf 5 is greater than or equal to 150 mm and less than or equal to 300 mm. The radius of the shelf 5 can be 160 mm, 165 mm, 170 mm, 175 mm, 180 mm, 185 mm, etc. By limiting the radius of the shelf 5, it is convenient to place objects while avoiding the volume of the shelf 5 from being excessively large, reducing the occupied space and thus facilitating storage.

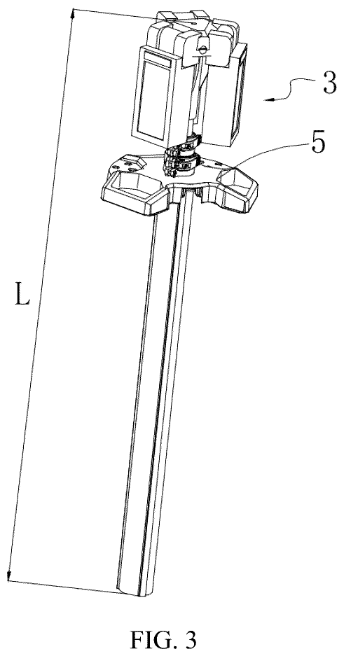

As shown in FIG. 3, in some embodiments, the height L of the stand light 100 in the storage state is less than or equal to 1000 mm. The height L of the stand light 100 or the light-emitting assembly 3 in the storage state can be 950 mm, 900 mm, 850 mm, 800 mm, 750 mm, 700 mm, etc. By limiting the height L of the stand light 100 in the storage state, the space occupied by the stand light 100 in terms of height can be further reduced, further reducing the space occupied by the stand light 100, thus facilitating storage.

As shown in FIG. 1 and FIG. 2, in some embodiments, the bracket locking switch 121 and the light switch are mounted on the elongate body 1. When the stand light 100 is in the storage state, the bracket locking switch 121 locks the position of the support legs 2 relative to the elongate body 1. When the stand light 100 needs to be used, the bracket locking switch 121 is pressed to unfold the support legs 2, thereby supporting the elongate body 1 to stand upright. At the same time, the light switch is pressed to control the lamp heads 31 to illuminate. The bracket locking switch 121 and the light switch can be integrated as a whole, allowing the stand light 100 to be used by a single operation. In other embodiments, the bracket locking switch 121 and the light switch can also be arranged separately to facilitate the corresponding operations according to actual needs, which are not further limited herein.

In some embodiments, the handle 12 is mounted on the elongate body 1 for being easily carried by the user. The bracket locking switch 121 and the light switch can be integrated on the handle 12 for easy operation by the user.

As shown in FIGS. 1-14, the present application provides a lamp. The lamp includes the elongate body 1, the light-emitting assembly 3, and a power source.

Specifically, the light-emitting assembly 3 is mounted to the elongate body 1, and the light-emitting assembly 3 includes at least one lamp head 31. The lamp head 31 includes the pivoting assembly 311 and the light-emitting panel 312. The power source is provided in the elongate body 1, and the power source supplies power to the light-emitting assembly 3. The pivoting assembly 311 includes the damping assembly 3114. The damping assembly 3114 includes the first deformation element 31141 surrounding the pivoting shaft 3115 of the pivoting assembly 311 and the second deformation element 31142 sleeved outside the first deformation element 31141. The second deformation element 31142 deforms under a radially inward pressure and compresses the first deformation element 31141. The first deformation element 31141 deforms under the compression of the second deformation element 31142 and generates a radially outward counterforce.

When the illumination angle of the light-emitting panel 312 is adjusted by rotation, a damping force is generated at the pivoting shaft 3115 due to the interaction of forces between the first deformation element 31141 and the second deformation element 31142. This ensures that the light-emitting panel 312 can be rotated to adjust the illumination angle, and moreover the light-emitting panel 312 can be maintained at the corresponding position after being adjusted to the corresponding angle. The above-mentioned arrangement allows for quick adjustment of the illumination angle of the lamp head 31 as needed, and is easy to operate.

In some embodiments, the second deformation element 31142 and the first deformation element 31141 shrink in diameter under a pressure. Under the pressure, the second deformation element 31142 is compressed and deformed, thus being shrunken in diameter. The first deformation element 31141 deforms under the pressure of the second deformation element 31142 to generate an elastic restoring force. The second deformation element 31142 is compressed and supported under the elastic restoring force of the first deformation element 31141, so that the second deformation element 31142 maintains the certain stiffness and elasticity, thereby effectively providing the damping effect.

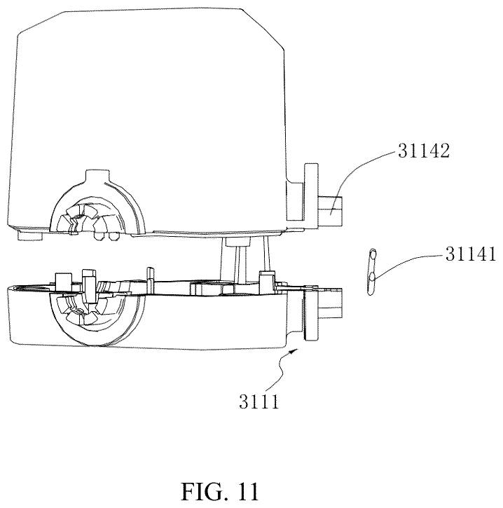

As shown in FIG. 11, in some embodiments, the first deformation element 31141 is the C-ring, and the second deformation element 31142 is the circumferential fin. The second deformation element 31142 is fixedly sleeved on the first deformation element 31141. When the second deformation element 31142 is subjected to a force, the circumferential fins approach each other, causing its diameter to decrease, thereby compressing the first deformation element 31141. The first deformation element 31141 is the C-ring, and an opening of the first deformation element 31141 is narrowed under the compressive force. Because the first deformation element 31141 has a certain degree of elasticity, it supports the second deformation element 31142 under its own elastic restoring force, allowing the second deformation element 31142 to maintain or increase a certain degree of elasticity. In some embodiments, the circumferential fin itself has strong resilience, and thus the C-ring can be omitted.

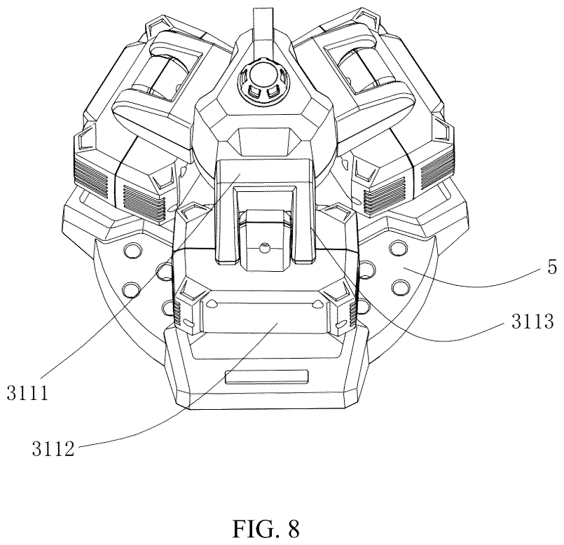

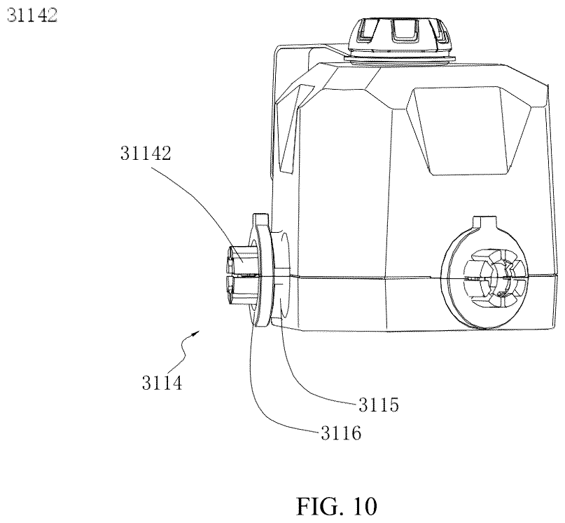

As shown in FIG. 8 and FIG. 10, in some embodiments, the pivoting assembly 311 includes the first component 3116 and the second component 3113 that rotate relative to each other. The damping assembly 3114 is provided on the first component 3116, and the second component 3113 applies a pressure to the second deformation element 31142. The first component 3116 of the pivoting assembly 311 is connected to the pivoting shaft 3115, and the second component 3113 is connected to the base 32 on which the lamp head 31 is mounted. The lamp head 31 is provided on the elongate body 1 via the base 32. During the adjustment of the illumination angle of the light-emitting panel 312, the first component 3116 rotates relative to the second component 3113. Due to the damping between the second deformation element 31142 and the second component 3113, the relative angle between the first component 3116 and the second component 3113 after rotation can be effectively limited.

In some embodiments, the torsion spring may be provided between the first component 3116 and the second component 3113. The torsion spring is sleeved on the pivoting shaft 3115, and a rotational friction is generated by the interference fit compression between the torsion spring and the second component 3113. When the lamp head 31 rotates, the torsion spring generates rotational damping.

In some embodiments, the rubber column may be provided between the first component 3116 and the second component 3113. The first component 3116 or the second component 3113 compresses the rubber column to generate rotational friction damping.

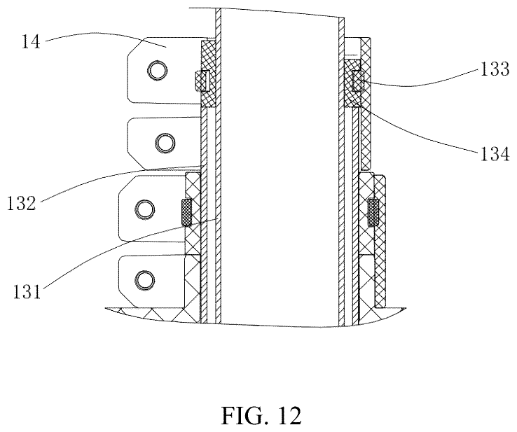

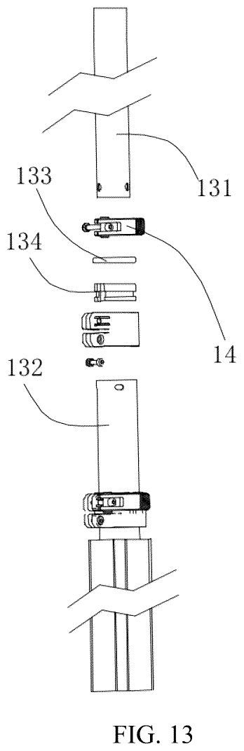

As shown in FIG. 1 and FIG. 12, in some embodiments, the lamp is the stand light 100. The elongate body 1 includes the telescopic tube assembly 13, and the telescopic tube assembly 13 includes at least the inner tube 131 and the outer tube 132. Clamps 14 are respectively fastened to the inner tube 131 and the outer tube 132 to secure the relative position of the inner tube 131 and the outer tube 132. By providing the telescopic tube assembly 13, the length of the inner tube 131 inserted into the outer tube 132 can be adjusted as needed, thereby adjusting the height of the elongate body 1. During the use of the stand light 100 at the construction site, the height of the elongate body 1 can be adjusted according to actual needs. During adjustment, the clamps 14 need to be only opened to achieve adjustment. After adjustment, the clamps 14 are locked to lock the relative position of the outer tube 132 and the inner tube 131. The above-mentioned structure facilitates operation.

As shown in FIGS. 12-13, in some embodiments, the telescopic tube assembly 13 further includes the elastic part 133, and the elastic part 133 is provided between the clamp 14 and the inner tube 131. By providing the elastic part 133, when the inner tube 131 moves along an axial direction of the inner tube 131, sliding friction exists between the inner tube 131 and the first elastic part 133, thereby providing damping and facilitating the operator to adjust the relative position between the inner tube 131 and the outer tube 132.

As shown in FIGS. 12-13, in some embodiments, the elastic part 133 is the rubber ring, and is fastened to the outside of the inner tube 131 by the plastic retaining ring 134. Specifically, the plastic retaining ring 134 is the C-shaped plastic part. After the elastic part 133 is sleeved on the plastic retaining ring 134, the plastic retaining ring 134 decreases in diameter under the action of the elastic part 133 and is secured to the outside of the inner tube 131. Furthermore, the plastic retaining ring 134 can be connected to the upper end of the outer tube 132 by adhesive bonding. During axial movement of the inner tube 131, sliding damping exists between the inner tube 131 and the plastic retaining ring 134, facilitating the operator to adjust the relative position between the inner tube 131 and the outer tube 132.

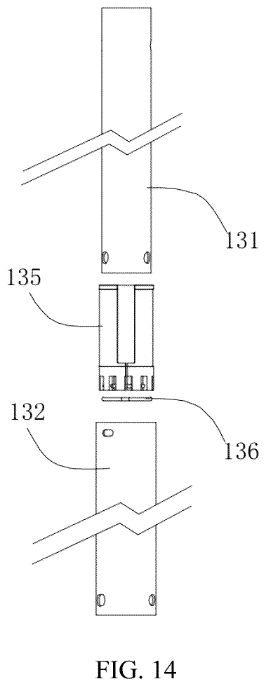

As shown in FIG. 14, in some embodiments, the first circumferential fin 135 made of a plastic part is fixed to the inner tube 131. Moreover, the C-shaped steel wire retaining ring 136 or the spring can be added to the inner ring of the circumferential fin to increase the elasticity of the first circumferential fin 135. The outer tube 132 is sleeved on the first circumferential fin 135, so that the diameter of the first circumferential fin 135 decreases. Under the elastic restoring force of the first circumferential fin 135, the first circumferential fin 135 abuts against the inner wall of the outer tube 132 to increase the sliding damping of the telescopic tube assembly 13. In some embodiments, the circumferential fin itself has strong resilience, and thus the C-ring can be omitted.

In some embodiments, the power source is AC power. The power source is connected to the AC wire of the mains supply, and the mains supply or other power source device cooperates with the corresponding rectification, filtering and voltage regulation circuits, so as to supply power to the lamp.

As shown in FIG. 1, in some embodiments, the power source is the battery pack 4. The rechargeable battery pack 4 is taken as the power source without the need for power cord installation, facilitating lamp reuse. After the battery pack 4 is fully discharged, it can be directly recharged for reuse.

In some embodiments, the battery pack 4 is detachable for powering a power tool. By designing the battery pack 4 as the detachable form, it can serve as the temporary power source for the power tool in emergency situations at the construction site, thereby effectively supporting on-site construction operations.

The basic principles, main features, and advantages of the present application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A stand light, comprising:
an elongate body defining a vertical axis of the stand light;
a plurality of support legs pivotally connected to the elongate body for supporting the elongate body to stand upright;
a light-emitting assembly mounted above the elongate body, wherein the light-emitting assembly comprises a base and a plurality of lamp heads; and
a battery pack mounted to the elongate body for supplying power to the light-emitting assembly;
wherein each of the plurality of lamp heads is independently arranged to rotate about a first axis and a second axis perpendicular to the first axis, wherein the first axis is a radial direction of the elongate body.

2. The stand light according to claim 1, wherein a position of the first axis is fixed relative to the base, and a position of the second axis changes as each of the plurality of lamp heads rotates along the first axis.

3. The stand light according to claim 1, wherein each of the plurality of lamp heads comprises a pivot knuckle, a pivot bracket and a light-emitting panel, wherein the pivot knuckle allows the pivot bracket and the light-emitting panel to rotate relative to the base about the first axis, and the pivot bracket allows the light-emitting panel to rotate relative to the pivot knuckle about the second axis.

4. The stand light according to claim 1, wherein first axes of the plurality of lamp heads are coplanar with the vertical axis, respectively.

5. The stand light according to claim 1, wherein a maximum rotation angle of each of the plurality of lamp heads about the first axis is 165°, and a maximum rotation angle of each of the plurality of lamp heads about the second axis is 310°.

6. The stand light according to claim 1, wherein the base is allowed to rotate relative to the elongate body about the vertical axis.

7. The stand light according to claim 1, wherein a shelf is mounted on the elongate body, the shelf is provided below the light-emitting assembly, the elongate body comprises a telescopic tube assembly, and a height difference between the shelf and the light-emitting assembly is adjusted by the telescopic tube assembly.

8. The stand light according to claim 7, further comprising a cover plate provided on a top of the telescopic tube assembly and a support plate provided below the cover plate, wherein the cover plate and the support plate form a circumferential groove, at least a part of the base is clamped in the circumferential groove, and the base is arranged to rotate about the circumferential groove.

9. The stand light according to claim 8, wherein an elastic element is provided between the base and the support plate or the cover plate.

10. The stand light according to claim 8, wherein a matching stop rib is provided between the base and the cover plate or the support plate, wherein the matching stop rib restricts a rotation angle of the base.

11. The stand light according to claim 3, wherein when the light-emitting assembly comprises three or fewer lamp heads, a plurality of light-emitting panels are allowed to rotate to have an approximately identical orientation.

12. A stand light, comprising:
an elongate body defining a vertical axis of the stand light;
a plurality of support legs pivotally connected to the elongate body for supporting the elongate body to stand upright;
a light-emitting assembly mounted above the elongate body, wherein the light-emitting assembly comprises a base and a plurality of lamp heads, and each of the plurality of lamp heads comprises a pivoting assembly and a light-emitting panel;
a battery pack mounted to the elongate body for supplying power to the light-emitting assembly; and
a shelf mounted on the elongate body and provided below the light-emitting assembly;
wherein the plurality of lamp heads are arranged to rotate until a plurality of light-emitting panels face the shelf, and when the plurality of light-emitting panels face the shelf, the shelf protrudes beyond the plurality of lamp heads in a radial direction of the elongate body.

13. The stand light according to claim 12, wherein taking the elongate body as a center, a radius of the shelf is greater than or equal to 150 mm and less than or equal to 300 mm.

14. The stand light according to claim 12, wherein the shelf is in a form of a tray or a loop.

15. The stand light according to claim 12, wherein a height of the stand light in a storage state is less than or equal to 1000 mm.

16. A lamp, comprising:
a body;
a light-emitting assembly mounted to the body, wherein the light-emitting assembly comprises at least one lamp head and a pivoting assembly; and
a power source provided in the body for supplying power to the light-emitting assembly;
wherein the pivoting assembly comprises a damping assembly, and the damping assembly comprises a first deformation element surrounding a pivoting shaft of the pivoting assembly and a second deformation element sleeved outside the first deformation element, wherein the second deformation element deforms under a radially inward pressure and compresses the first deformation element, and the first deformation element deforms under compression of the second deformation element and generates a radially outward counterforce.

17. The lamp according to claim 16, wherein the second deformation element and the first deformation element shrink in diameter under the radially inward pressure.

18. The lamp according to claim 16, wherein the first deformation element is a C-ring, and the second deformation element is a circumferential fin.

19. The lamp according to claim 16, wherein the pivoting assembly comprises a first component and a second component, wherein the first component and the second component rotate relative to each other, the damping assembly is provided on the first component, and the second component applies the radially inward pressure to the second deformation element.

20. The lamp according to claim 16, wherein the lamp is a stand light, the body comprises a telescopic tube assembly, the telescopic tube assembly comprises at least an inner tube and an outer tube, and a relative position of the inner tube and the outer tube is limited by a clamp.
